(19) United States
(12) Patent Application Publication
(10) Pub. No.: US 2011/0243641 A1
(43) Pub. Date: Oct. 6, 2011

(54) STYLUS

(75) Inventor: WEI DU, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/781,835

(22) Filed: May 18, 2010

(30) Foreign Application Priority Data
Mar. 30, 2010 (CN) 201010135542.1

(51) Int. Cl. B43K 29/10

(52) U.S. Cl. 401/195

(57) ABSTRACT

A stylus includes a tube, a head engaged with a first end of the tube, and a cap engaged with a second end opposite the first end of the tube. The cap includes a power source inside the cap. A button is formed on a first end of the cap to control the power source. A light body extends from a second end opposite to the first end of the cap and is electrically connected to the power source. The light body is accommodated in the tube.

### BACKGROUND

1. Technical Field

The present disclosure relates to a stylus.

2. Description of Related Art

Due to small size and strong function, personal digital assistants (PDAs) are widely used. In order to be conveniently operated, a PDA usually includes a touch-sensitive display, and a user can use a stylus to touch the touch screen to operate the PDA. The stylus generally includes a fill made of magnetic material and a plastic outer shell encasing the fill. However, the outer shell is usually a smooth surface merely spray painted or metal plated for decoration, which has become too common and not has aesthetic appeal to some users.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a stylus.

FIG. 2 is an assembled, isometric view of the stylus of FIG. 1.

### DETAILED DESCRIPTION

The disclosure, including the accompanying drawings in which like references indicate similar elements, is illustrated by way of example and not by way of limitation. It should be noted that references to “an” or “one” embodiment in this disclosure are not necessarily to the same embodiment, and such references mean at least one.

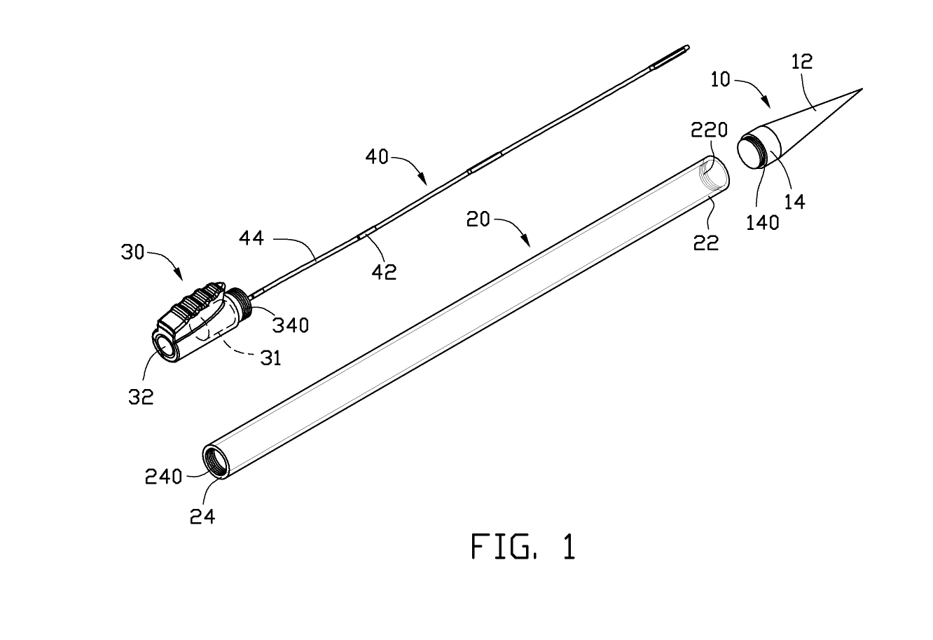

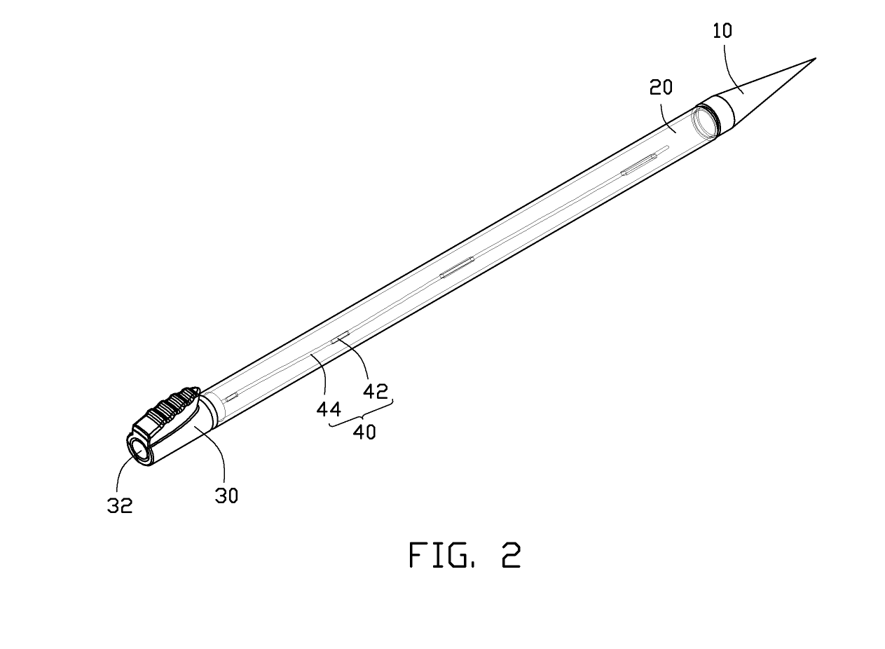

Referring to FIGS. 1 and 2, an exemplary embodiment of a stylus includes a head 10, a tube 20, and a cap 30.

The head 10 includes a fill (not shown) made of magnetic material. The fill is encased by a plastic outer shell, forming a tapered portion 12 and a cylindrical connecting portion 14 extending from a larger end of the tapered portion 12. A distal end of the connecting portion 14 has an external threaded portion 140.

The tube 20 is made of plastic material or glass material to be transparent or translucent, and includes a first end 22 and a second end 24 opposite to the first end 22. An inner surface of the first end 22 defines a threaded portion 220, and an inner surface of the second end 24 defines a threaded portion 240.

The cap 30 is cylinder-shaped and includes a power source 31 inside the cap 30. A first end of the cap 30 forms a button 32 to control the power source 31 to power on or power off the stylus. A second end opposite the first end of the cap 30 defines an externally threaded portion 340. A lighting body 40 extends from the second end of the cap 30 and is electrically connected to the power source 31. The lighting body 40 includes a plurality of lighting elements 42 and conductive wires 44. The plurality of lighting elements 42 is electrically connected via the conductive wires 44 to the power source 31. In this embodiment, the lighting elements 42 are light emitting diodes.

Referring to FIG. 2, in assembly, the head 10 is fixed to the first end 22 of the tube 20 via engagement between the threaded portions 140 and 220. A plurality of fluorescent powders is stowed in the tube 20 through the second end of the tube 20, and the lighting body 40 is inserted in the tube 20. The cap 30 is fixed to the second end 24 of the tube 20 by engagement between the threaded portions 340 and 240.

In use, the button 32 is triggered to make the power source 31 supply power to the lighting body 40. The plurality of lighting elements 42 light and shine on the fluorescent powders, making the stylus colorful.

In other embodiments, the fluorescent powders may be omitted, and the plurality of lighting elements 42 can instead be different color light emitting diodes. When the power source 31 supplies power to the lighting body 40, the lighting elements 42 light up in different colors, making the stylus colorful.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A stylus comprising:
a tube;
a head engaged with a first end of the tube; and
a cap;
wherein the cap includes a power source inside the cap, a button is formed on a first end of the cap to control the power source, a lighting body extends from a second end opposite to the first end of the cap and is electrically connected to the power source, the second end of the cap is engaged with a second end of the tube, with the lighting body accommodated in the tube.

2. The stylus of claim 1, wherein the tube is transparent or translucent.

3. The stylus of claim 2, wherein the tube is made of plastic material or glass material.

4. The stylus of claim 1, wherein a plurality of fluorescent powders is stowed in the tube.

5. The stylus of claim 1, wherein the lighting body comprises a plurality of conductive wires and a plurality of lighting elements electrically connected to the power source via the wires.

6. The stylus of claim 5, wherein the plurality of lighting elements comprises different color light emitting diodes.
